(19) United States
(12) Patent Application Publication
(10) Pub. No.: US 2012/0289069 A1
(43) Pub. Date: Nov. 15, 2012

(54) Apparatus for Blocking I/O Interfaces of Computing Devices

(75) Inventors: Chia-Liang Chueh, Chiayi City (TW); Hong-Yi Wu, Hsin-Chu (TW); Yeh-Chieh Wang, Hsin-Chu (TW); Chih-Yee Chen, Hsin-Chu (TW); Jiun-Rong Pai, Jhubei City (TW)

(73) Assignee: Taiwan Semiconductor Manufacturing Company, Ltd., Hsin-Chu (TW)

(21) Appl. No.: 13/107,518

(22) Filed: May 13, 2011

(51) Int. Cl. H01R 13/44

(52) U.S. Cl. 439/135

(57) ABSTRACT

An input/output (I/O) interface blocking device includes a fitting member. The fitting member includes a protruding portion, which includes a first sidewall and a second sidewall opposite to each other. The first sidewall is slanted in a direction allowing the first fitting member to be inserted into a space in an I/O interface receptacle. The second sidewall is configured to block the fitting member from being pulled out of the space in the I/O interface receptacle.

### BACKGROUND

Computing devices such as computers include input/output (I/O) interfaces, which include universal serial bus (USB) ports, IEEE 1394 ports, and/or the like. While the I/O interfaces make easy the information exchange between the computers and external devices such as USB portable drives, it also makes unauthorized copying of information easy. Therefore, the I/O interfaces may need to be blocked from being accessed in certain situations.

Currently, there are various approaches for blocking the unauthorized use of the I/O interfaces, including software approaches and hardware approaches. The I/O interfaces can be disabled through software, for example, by modifying the register keys of the I/O interfaces, modifying the configuration in BIOS, and/or installing dedicated software. However, it is difficult to tell whether an I/O interface has been disabled or not if the software approaches are taken.

The hardware approaches for disabling I/O interfaces include sealing the I/O interfaces by melting and filling adhesives into the I/O interfaces, filling solder into the I/O interfaces, or removing the I/O interfaces. These methods may cause short circuit and damage to other devices, and may cause particle issues in some locations that have demanding requirements to the air quality, such as in the clean room of a semiconductor manufacturing factory.

### BRIEF DESCRIPTION OF THE DRAWINGS

For a more complete understanding of the embodiments, and the advantages thereof, reference is now made to the following descriptions taken in conjunction with the accompanying drawings, in which:

FIG. 1 illustrates a perspective view of a universal serial bus (USB) connector receptacle;

FIG. 2 is a perspective view of a fitting member for blocking the USB connector receptacle in accordance with an embodiment;

FIG. 3 is a perspective view of the fitting member, wherein fitting members are detached from a cap of the fitting member;

FIGS. 4 through 6 are cross-sectional view of intermediate stages in the insertion of the fitting member into the USB connector receptacle; and

FIG. 7 illustrates a perspective view of a structure with the fitting members of the fitting member locked in the connector receptacle.

### DETAILED DESCRIPTION OF ILLUSTRATIVE EMBODIMENTS

The making and using of the embodiments of the disclosure are discussed in detail below. It should be appreciated, however, that the embodiments provide many applicable inventive concepts that can be embodied in a wide variety of specific contexts. The specific embodiments discussed are merely illustrative, and do not limit the scope of the disclosure.

An apparatus for blocking input/output (I/O) devices is provided in accordance with an embodiment. The variations and the operation of the embodiment are discussed. Throughout the various views and illustrative embodiments, like reference numbers are used to designate like elements. Throughout the description, although the blocking of a universal serial bus (USB) connector receptacle is used as an example, the teaching of the embodiments is not limited to the blocking of USB connector receptacles, and other types of I/O device receptacles, such as IEEE 1394 connector receptacles, external serial advanced technology attachment (SATA) receptacles, local area network (LAN) RJ45 port receptacles or the like, may also be blocked using the apparatus in accordance with embodiments.

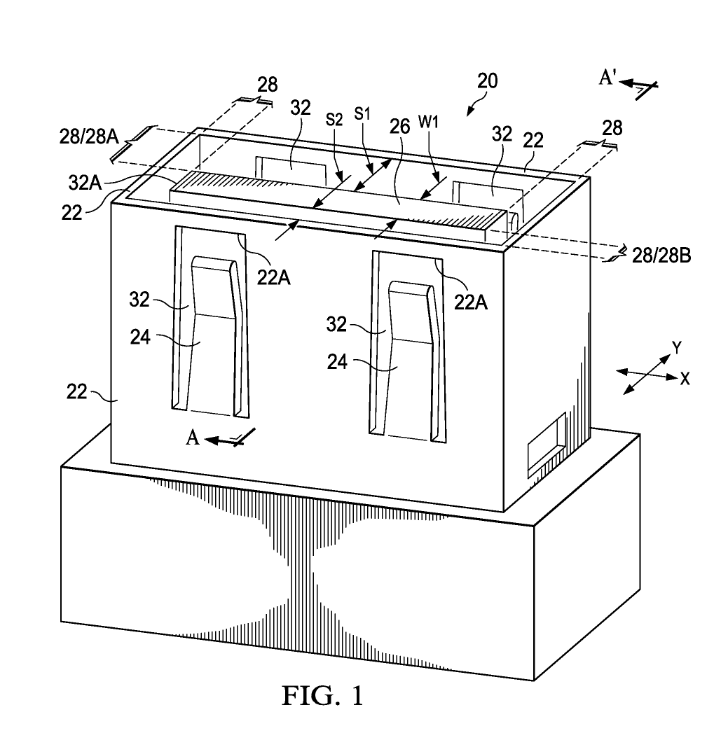

FIG. 1 illustrates a perspective view of USB connector receptacle 20, which includes shell 22, springs 24, and connection contact substrate 26. It is noted that USB connector receptacle 20 as in FIG. 1 is an exemplary, and USB connector receptacle 20 may have different designs compliant with USB standards. Electrical contacts (not shown) are formed on connection contact substrate 26. Spaces 28 (including 28A and 28B) separate connection contact substrate 26 from shell 22. Springs 24 are located in openings 32 of shell 22. Springs 24 may be attached to shell 22, and are configured to be flattened under force. With no force being applied, springs 24 have a V-shape including two portions that form the two legs of the V-shape. Shell 22 may be formed of a metal or a metal alloy, although it may also be formed of other materials. Shell 22 may be slightly flexible, and when under force, the shape of shell 22 may be changed slightly, and may expand in X and/or Y directions, for example. Particularly, in the embodiments, shell 22 may expand in the Y directions in accordance with embodiment.

Spaces 28 surround connection contact substrate 26 when viewed from the top of the structure shown in FIG. 1. Space 28 may include portion 28A and portion 28B on opposite sides of connection contact substrate 26. The width of connection contact substrate 26 is indicated as W1. Portions 28A and 28B may have different sizes, with spacings S1 and S2 indicating the respective dimensions of portions 28A and 28B, wherein dimensions S1 and S2 are measured in the Y directions.

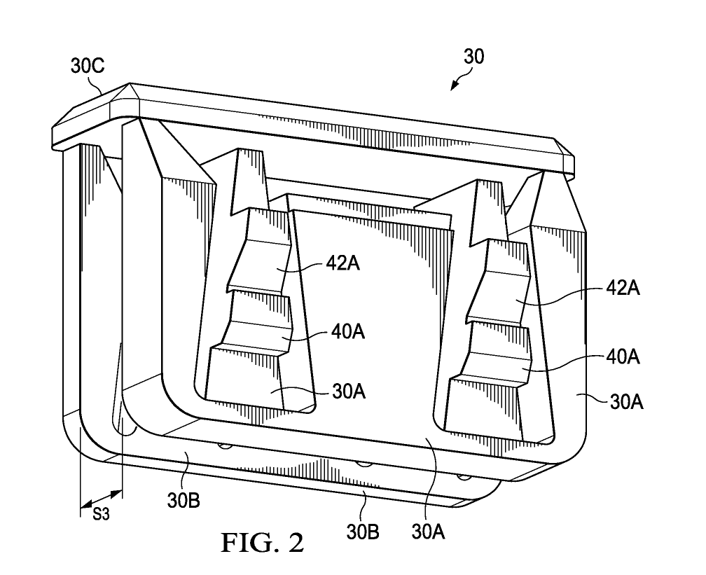

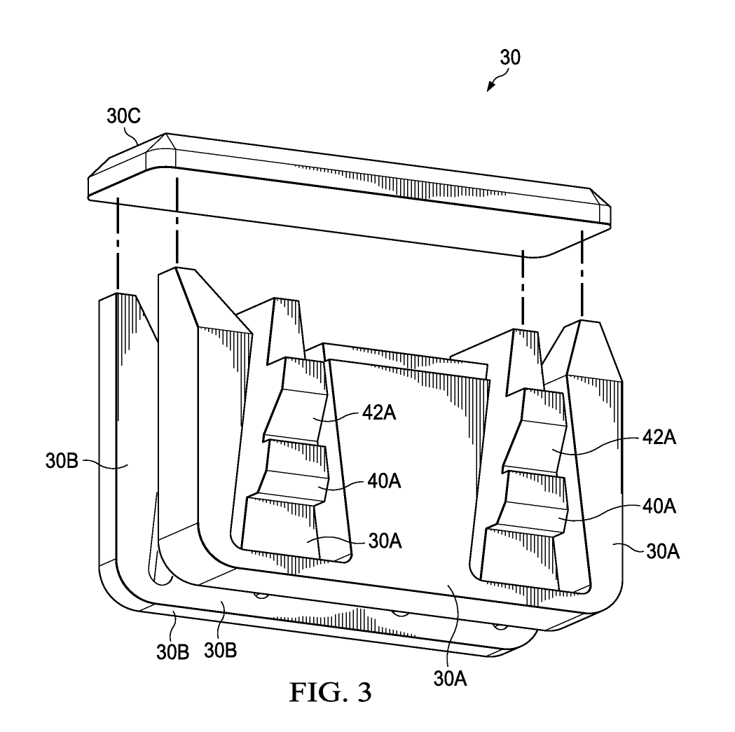

FIG. 2 illustrates a perspective view of fitting member 30, which includes fitting member 30A configured to be inserted into portion 28A of space 28 (FIG. 1), fitting member 30B configured to be inserted into portion 28B of space 28, and cap 30C. Fitting member 30 may be formed of dielectric materials, such as plastics, ceramics, or the like. Spacing S3 between fitting members 30A and 30B may be substantially equal to width W1 of connection contact substrate 26 (FIG. 1). Fitting members 30A and 30B are attached to cap 30C. In an embodiment, the attachment is achieved through an adhesive (not shown). Alternatively, the attachment is achieved through other means such as nailing, screwing, latching, or the like. In yet other embodiments, the attachment is achieved through forming narrow portions to connect fitting members 30A and 30B to cap 30C, wherein the narrow portions can easily break under force. When a force is applied, cap 30C may be detached from fitting members 30A and 30B, so that fitting member 30 is separated into three pieces. FIG. 3 illustrates the perspective view of the detached pieces 30A, 30B, and 30C.

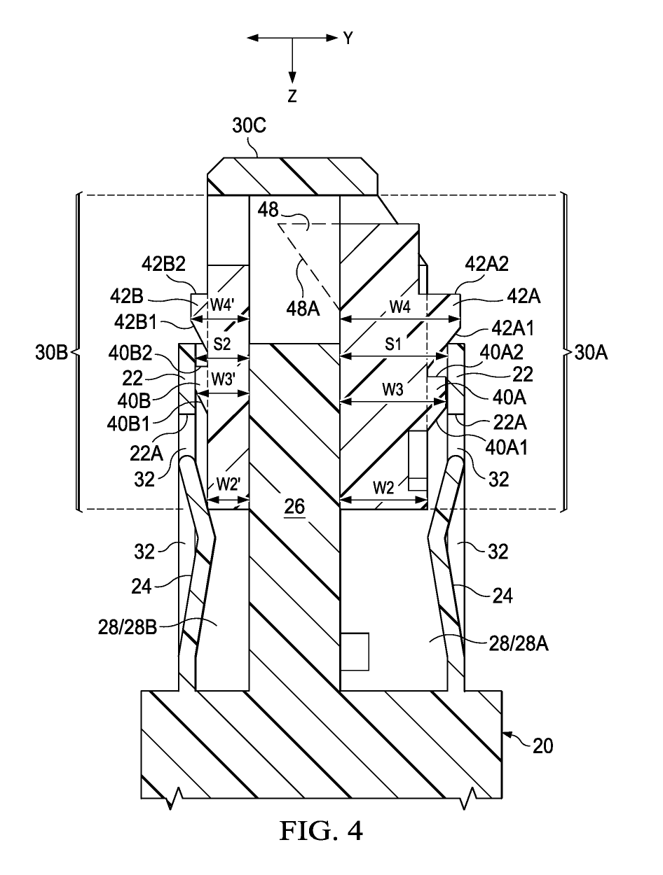

FIGS. 4 through 6 are cross-sectional views illustrating the insertion of first fitting member 30A and second fitting member 30B into spaces 28A and 28B (FIG. 1), respectively. The cross-sectional views are obtained from the plane crossing line A-A′ in FIG. 1. Referring to FIG. 4, fitting members 30A and 30B includes protruding portions 40 (including 40A and 40B) and 42 (including 42A and 42B) that protrude above remaining portions of fitting members 30A and 30B, wherein protruding portions 40 and 42 face openings 32 in shell 22 (also refer to FIG. 1). Optionally, one or both fitting members 30A and 30B may include protruding portion 48 that faces connection contact substrate 26.

Referring to fitting member 30A, width W3 of fitting member 30A is greater than with W2 of a portion of fitting member 30A that does not include protruding portions, wherein width W3 is measured where protruding portion 40A is located, and width W2 is measured where no protruding portion is formed. Width W4 of fitting member 30A may be greater than widths W2 and W3, wherein width W4 is measured where protruding portion 42A is located. Width W4 may be greater than spacing S1, wherein spacing S1 is measured when shell 22 is not expanded under force. Similarly, width W3′ of fitting member 30B is greater than with W2′ of a portion of fitting member 30B that does not include protruding portions, wherein width W3′ is measured where protruding portion 40B is located, and width W2′ is measured where no protruding portion is formed. Width W4′ of fitting member 30B may be greater than widths W2′ and W3′, wherein width W4′ is measured where protruding portion 42B is located. Width W4′ may be greater than spacing S2, wherein spacing S2 is measured when shell 22 is not expanded under force. Each of protruding portions 40 and 42 includes a corresponding slanted sidewall 40A1/40B1/42A1/42B1 and a substantially vertical sidewall 40A2/40B2/42A2/42B2 that are substantially perpendicular to the insertion direction, which is illustrated as Z direction. In alternative embodiments, sidewalls 40A2, 40B2, 42A2 and/or 42B2 may also be slanted in a same direction as sidewalls 42A1 and 42B1. Each of the slanted sidewalls 40A1, 40B1, 42A1, 42B1, and 48A (of protruding portion 48) may slant in the direction that allows the respective protruding portions slide into spaces 28.

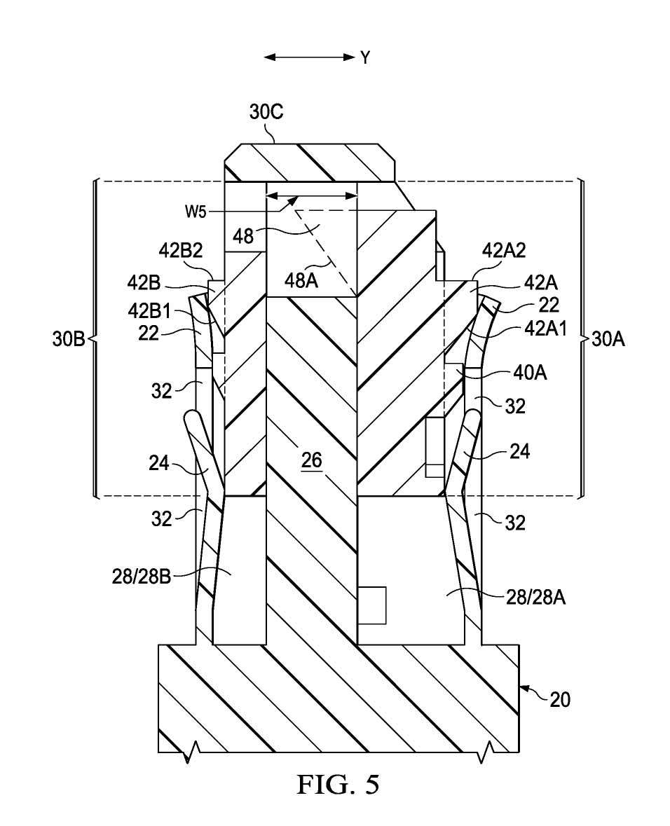

In a first stage of the insertion, as show in FIG. 4, widths W2 and W2′ of the portions inserted into USB connector receptacle 20 are substantially equal to or smaller than the respective spacing S1 or S2. Accordingly, the shape of shell 22 is not changed, and shell 22 is not expanded in the Y-directions. The insertion is continued to so that fitting members 30A and 30B proceed more into spaces 28A and 28B, until a second stage is reached, and protruding portions 42A and 42B are blocked by shell 22. At this time, a force is applied to force fitting members 30A and 30B into spaces 28. Since shell 22 is flexible, the spacings between connection contact substrate 26 and shell 22 are expanded, and fitting members 30A and 30B may continue to move forward. FIG. 5 illustrates the expansion of shell 22 and the positions of fitting members 30A and 30B.

With the further proceeding of the insertion, the optional protruding portion 48 may reach connection contact substrate 26. Further insertion thus causes the illustrated fitting member 30A to move away from (in the Y direction) connection contact substrate 26, and in turn causes the further expansion of shell 22 in the Y directions. In an exemplary embodiment, width W5 of protruding portion is about 1.5 mm. Accordingly, fitting member 30A is pushed to the right for about 1.5 mm, and the respective shell 22 expands accordingly.

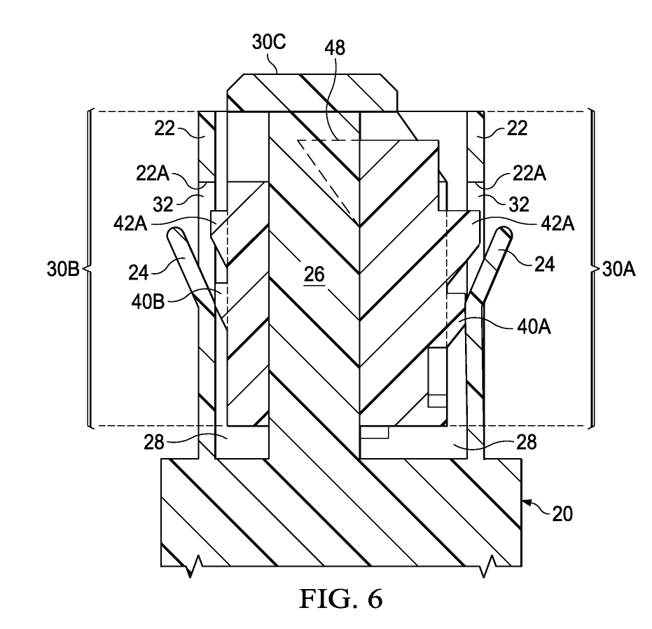

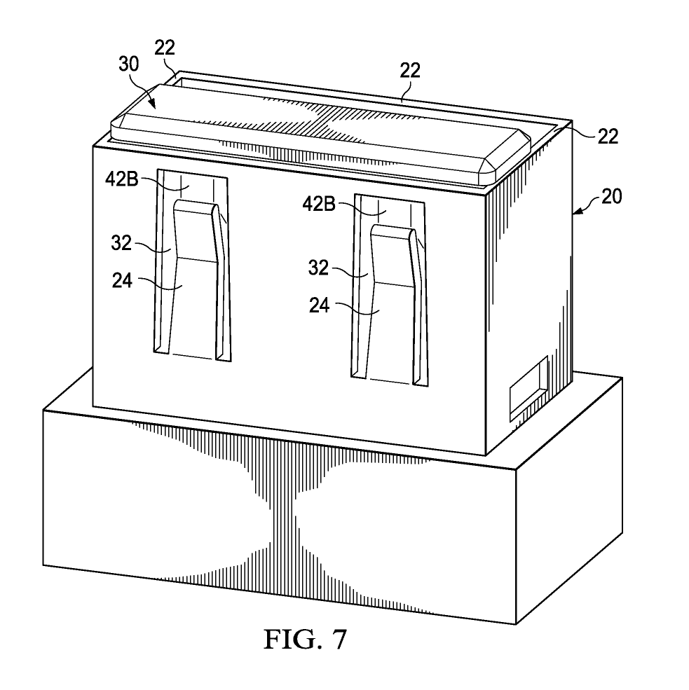

FIG. 6 illustrates a third stage of the insertion, after which fitting members 30A and 30B are substantially fully inserted into spaces 28, and are locked into positions. Protruding portions 40A and 40B have the function of flattening springs 24, and may have the function of being locked on springs 24 in some USB connector receptacles (not shown) that have other designs. At least portions of protruding portions 42A and 42B are inserted into openings 32 of shell 22, and sidewalls 42A2 and 42B2 move to the points below edges 22A of openings 32. Accordingly, fitting members 30A and 30B are locked in USB connector receptacle 20. At this stage, shell 22 may have its shape restored back to the original shape before fitting members 30A and 30B are inserted. Alternatively, shell 22 may stay expanded slightly, for example, when protruding portion 48 is formed. With fitting members 30A and 30B locked into positions, if a force is applied to try to pull fitting members 30A and/or 30B out of USB connector receptacle 20, sidewalls 42A2 and 42B2 of protruding portions 42A/42 are blocked by edges 22A. Therefore, fitting member 30 prevents USB connector receptacle 20 from being used. Furthermore, fitting members 30A and 30B, after being inserted into USB connector receptacle 20, may be un-removable unless USB connector receptacle 20 is damaged. FIG. 7 illustrates a perspective view of the resulting structure after fitting member 30 is inserted into USB connector receptacle 20.

In an embodiment, cap 30C and fitting members 30A and 30B are detachable. Therefore, if the force for pulling fitting members 30A and 30B out of USB connector receptacle 20 is greater enough, cap 30C is detached from the respective fitting members 30A and 30B, as shown in FIG. 3 (USB connector receptacle 20 is omitted in FIG. 3). The attachment between cap 30C and fitting members 30A and 30B is so configured so that the force for detaching cap 30C from fitting member 30A and 30B will not cause the damage of USB connector receptacle 20 and surrounding devices. With cap 30C detached from fitting members 30A and 30B, it is more difficult to remove fitting members 30A and 30B from USB connector receptacle 20.

In accordance with embodiments, the blocking of I/O interfaces includes merely the step of inserting fitting member 30 into the I/O interfaces, and hence the blocking may be performed quickly. It can also be quickly determined whether an I/O interface has been successfully blocked from been accessed or not. Furthermore, there is no side effect such as particles, circuit shorting, etc.

In accordance with embodiments, an I/O interface blocking device includes a fitting member. The fitting member includes a protruding portion, which includes a first sidewall and a second sidewall opposite to each other. The first sidewall is slanted in a direction allowing the first fitting member to be inserted into a space in an I/O interface receptacle. The second sidewall is configured to block the fitting member from being pulled out of the space in the I/O interface receptacle.

In accordance with other embodiments, an I/O interface blocking device includes a cap, and a fitting member attached to the cap. The fitting member is configured to be inserted into, and locked in, a USB connector receptacle. The cap is detachable from the fitting member.

In accordance with yet other embodiments, a method includes inserting a portion of a fitting member of an I/O interface blocking device into a space of an I/O interface receptacle until a first sidewall of a protruding portion of the fitting member causes an expansion of a shell of the I/O interface receptacle. The method further includes continuing to insert the fitting member into the space of the I/O interface receptacle until a portion of the protruding portion inserted into an opening of the shell and until the shell restores shape from expansion. A second sidewall of the protruding portion blocks the fitting member from being pulled out of the I/O interface receptacle.

Although the embodiments and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. An input/output (I/O) interface blocking device comprising:
a first fitting member comprising a first protruding portion comprising:
a first sidewall, wherein the first sidewall is slanted in a direction allowing the first fitting member to be inserted into a space in an I/O interface receptacle; and
a second sidewall configured to block the fitting member from being pulled out of the space in the I/O interface receptacle, wherein the first and the second sidewalls are opposite sidewalls of the first protruding portion.

2. The I/O interface blocking device of claim 1, wherein the first sidewall is configured to, with a proceeding of an insertion process of the first fitting member into the space, push a shell of the I/O interface receptacle to cause an expansion of the shell.

3. The I/O interface blocking device of claim 1 further comprising a second fitting member comprising a second protruding portion comprising:
a third sidewall, wherein the third sidewall is slanted in the direction allowing the second fitting member to be inserted into an additional space in the I/O interface receptacle; and
a fourth sidewall configured to block the fitting member from being pulled out of the additional space in the I/O interface receptacle, wherein the third and the fourth sidewalls are opposite sidewalls of the second protruding portion.

4. The I/O interface blocking device of claim 1 further comprising a cap attached to an end of the first fitting member, wherein the cap is configured to cover the I/O interface receptacle when the first fitting member is inserted into the I/O interface receptacle.

5. The I/O interface blocking device of claim 4, wherein the cap is detachable from the first fitting member.

6. The I/O interface blocking device of claim 1, wherein the first protruding portion faces an opening in a shell of the I/O interface receptacle, wherein the I/O interface blocking device further comprises a second protruding portion, and wherein the first and the second protruding portions face opposite directions.

7. The I/O interface blocking device of claim 1, wherein the first fitting member is formed of a dielectric material.

8. The I/O interface blocking device of claim 1, wherein the second sidewall is substantially vertical to an insertion direction, with the first fitting member being inserted into the space in the insertion direction.

9. The I/O interface blocking device of claim 1, wherein the I/O interface receptacle is a universal serial bus (USB) connector receptacle.

10. An input/output (I/O) interface blocking device comprising:
a cap; and
a first fitting member attached to the cap, wherein the first fitting member is configured to be inserted into, and is configured to be un-removable from, an I/O interface receptacle, and wherein the cap is detachable from the first fitting member so that the first fitting member is configured to remain locked in the I/O interface receptacle when the cap is detached from the first fitting member.

11. The I/O interface blocking device of claim 10 further comprising a second fitting member attached to the cap, wherein the second fitting member is configured to remain in the I/O interface receptacle when detached from the cap, and wherein the second fitting member is configured to be physically separated from the first fitting member when detached from the cap.

12. The I/O interface blocking device of claim 10, wherein the first fitting member comprises a portion having a width greater than a respective width of a space of the I/O interface receptacle, wherein the width of the portion and the width of the space are measured in a same direction perpendicular to an insertion direction in which the first fitting member is inserted into the space, and wherein the portion comprises a protruding portion extending into an opening of a shell of the I/O interface receptacle when the first fitting member is inserted into the space.

13. The I/O interface blocking device of claim 12, wherein the protruding portion comprises:
a first sidewall, wherein the first sidewall is configured to push and expand the shell when the first fitting member is inserted into the space; and
a second sidewall configured to block the first fitting member from being pulled out of the space of the I/O interface receptacle, wherein the first and the second sidewalls are opposite sidewalls of the protruding portion.

14. The I/O interface blocking device of claim 13, wherein the second sidewall is substantially perpendicular to an insertion direction for the first fitting member being inserted into the I/O interface receptacle.

15. The I/O interface blocking device of claim 14, wherein the first fitting member is formed of a dielectric material.

16. A method comprising:
inserting a portion of a fitting member of an input/output (I/O) interface blocking device into a space of an I/O interface receptacle until a first sidewall of a protruding portion of the fitting member causes an expansion of a shell of the I/O interface receptacle; and
continuing to insert the fitting member into the space of the I/O interface receptacle until a portion of the protruding portion inserted into an opening of the shell and until the shell restores shape from expansion, wherein a second sidewall of the protruding portion blocks the fitting member from being pulled out of the I/O interface receptacle.

17. The method of claim 16 further comprising, after the fitting member is inserted into, and locked in, the I/O interface receptacle, detaching a cap of the I/O interface blocking device from the fitting member, with the fitting member left in the space of the I/O interface receptacle.

18. The method of claim 16, wherein the I/O interface blocking device further comprises an additional fitting member, wherein when the fitting member is inserted into the I/O interface receptacle, the additional fitting member is further locked in the I/O interface receptacle, with an additional protruding portion of the additional fitting member including a portion inserted into an addition opening of the shell, so that the additional fitting member is blocked from being pulled out of the I/O interface receptacle.

19. The method of claim 16, wherein the I/O interface receptacle is a universal serial bus (USB) connector receptacle.

20. The method of claim 16, wherein after the portion of the protruding portion is inserted into the opening of the shell, the shape of the shell is restored back to a shape before the fitting member is inserted into the space.
